(19) United States
(12) Patent Application Publication
(10) Pub. No.: US 2016/0068405 A1
(43) Pub. Date: Mar. 10, 2016

(54) SOLUTION BASED SYNTHESIS OF COPPER-ARSENIC-CHALCOGEN NANOPARTICLES

(71) Applicant: Purdue Research Foundation, West Lafayette, IN (US)

(72) Inventors: Rakesh Agrawal, West Lafayette, IN (US); Robert B. Balow, Alexandria, VA (US)

(73) Assignee: Purdue Research Foundation, West Lafayette, IN (US)

(21) Appl. No.: 14/842,690

(22) Filed: Sep. 1, 2015

Related U.S. Application Data
(60) Provisional application No. 62/046,764, filed on Sep. 5, 2014.

(51) Int. Cl. C01G 28/00; H01B 1/02

(52) U.S. Cl. CPC C01G 28/008; H01B 1/02; C01P 2006/40

(57) ABSTRACT

Disclosed herein are synthesis methods and uses of nanoparticles containing copper, arsenic, and chalcogen, in particular their use for making thin films useful for electronics, photovoltaics, and solar energy conversion devices.

### CROSS-REFERENCE TO RELATED APPLICATIONS

The present U.S. patent application is related to and claims the priority benefit of U.S. Provisional Patent Application Ser. No. 62/046,764, filed Sep. 5, 2014, the contents of which is hereby incorporated by reference in its entirety into this disclosure.

### STATEMENT OF GOVERNMENT INTEREST

This invention was made with government support under DGE-0903670 awarded by the National Science Foundation. The government has certain rights in the invention.

### TECHNICAL FIELD

The present disclosure generally relates to synthesis methods and uses of nanoparticles containing copper, arsenic, and chalcogen, in particular their use for making thin films useful for electronics, photovoltaics, and solar energy conversion devices.

### BACKGROUND

This section introduces aspects that may help facilitate a better understanding of the disclosure. Accordingly, these statements are to be read in this light and are not to be understood as admissions about what is or is not prior art.

Semiconducting nanoparticles (NPs) are important for several applications including electronics, light emitting diodes, sensors, and solar cells. By suspending NPs in a solvent, a NP “ink” can be formulated enabling printing or spray coating of semiconducting compounds. Solar absorber materials produced from these NP inks, offer a low cost and highly scalable route to solar cell production compared to vacuum processing. Significant progress has been made with Cu(In,Ga)(S,Se)₂ (CIGSSe) NPs reaching a power conversion efficiency of 15%.

Derived from a similar zinc-blende based crystal structure as CIGSSe, earth abundant copper-arsenic-chalcogen (CAS) containing compounds such as tetragonal luzonite (Cu₃AsS₄, LUZ) and cubic tennantite (Cu₁₂₊ₓAs_{4+y}S₁₃, TEN) are expected to have similar electrical properties as CIGSSe such as p-type conductivity, direct band gap transition, and ideal band gap energy for use in solar conversion materials. Currently, there is no reported NP synthesis of these materials despite their favorable semiconductor properties. A solution based synthesis of CAS NPs is therefore of great interest due to ease of synthesis and new manufacturing opportunities.

### SUMMARY

In one aspect, a method for obtaining copper, arsenic, and chalcogen containing nanoparticles is described. The method includes the steps of providing a first group of precursors, the first group of precursors comprising copper and arsenic, providing a second group of precursors, the second group of precursors comprising sulfur, selenium, tellurium, or a mixture thereof, and reacting both the first group of precursors and the second group of precursors in at least one solvent at conditions forming copper arsenic chalcogen nanoparticles. In another aspect, the copper arsenic and chalcogen containing nanoparticles can have an atomic composition denoted by Cu_{3-w}As(S₁₋ₓ,Se_{1-y},Te_{1-z})₄ where −0.75≦w≦0.5, x+y+z=1, 0≦x,y,z≦1. The first group of precursors include at least one copper and arsenic component from at least one of elemental copper, arsenic, or combination thereof, alloy of copper, arsenic, or a combination thereof, salt of copper, arsenic, or combination thereof, organic complex of copper, arsenic, or combination thereof, and chalcogenide of copper, arsenic, or combination thereof.

In another aspect, the second group of precursors can include sulfur, selenium, tellurium, or combination with at least one of elemental sulfur, selenium, tellurium, or combination thereof, compound of sulfur, selenium, tellurium, or combination thereof, and a complex of sulfur, selenium, tellurium, or combination thereof. The solvent can include at least one alkane, alkene, alkane derivatives, alkene derivatives, or a mixture thereof. The alkane or alkene derivative can include at least one functional group comprising an amine, an amide, a carbonate, a carboxylic acid, an ether, a phosphine, a phosphonic acid, a thiol, or a combination thereof. In yet another aspect, the first and second group of precursors are suspended in one or more solvents forming a reaction mixture. In yet another aspect, the method also includes the steps of suspending the first group of precursors in one or more solvents forming precursor solution A, suspending the second group of precursors in one or more solvents forming precursor solution B, and combining precursor solutions A and B in a reaction flask containing one or more solvents forming a reaction mixture.

In yet another aspect, the method can include the steps of conducting the reaction at a temperature between about 50° C. and about 350° C. In yet another aspect, the disclosed method can include the steps of heating one or more reaction solvents to between about 50° C. and 350° C., adding precursor solutions A, and adding precursor solution B, heating one or more reaction solvents to between about 50° C. and 350° C., adding precursor solutions A and B simultaneously, heating one or more reaction solvents to between about 50° C. and about 350° C., adding a solution containing one or more solvents and all precursors, and heating all precursors in one or more solvents to between about 50° C. and 350° C.

In yet another aspect, the disclosed method can include the steps of increasing reaction temperature after the addition of one or more precursors, decreasing reaction temperature after the addition of one or more precursors, and maintaining of reaction temperature after the addition of one or more precursors. In yet another aspect, heating the reaction mixture between about 50° C. to about 250° C. can give copper arsenic sulfide nanoparticles with a tetragonal crystal structure, hexagonal crystal structure, or combination thereof. In yet another aspect, heating the reaction mixture between about 250° C. and 350° C. can give copper arsenic sulfide nanoparticles with a cubic crystal structure. In another aspect, the nanoparticles are collected by centrifugation after the reaction of precursors in the reaction mixture.

### BRIEF DESCRIPTION OF THE FIGURES

FIG. 1 is a schematic diagram of the typical glassware used in the synthesis of CAS NPs.

FIG. 2 shows the obtained Raman spectra of the as synthesized CAS NPs at two different reaction temperatures.

FIG. 3 shows the X-ray diffraction patterns of the CAS NPs synthesized at various temperatures with identified lattice planes.

FIG. 4 shows the X-ray diffraction pattern of copper arsenic selenide (CASe) NPs synthesized at 175° C. with identified lattice planes.

FIG. 5 is a transmission electron microscopy (TEM) image of as synthesized CAS NPs at 175° C. after a typical washing procedure depicting a tetragonal crystal structure.

FIG. 6 is a TEM image of as synthesized CAS NPs at 250° C. after a typical washing procedure depicting a cubic crystal structure.

FIG. 7 shows the X-ray diffraction pattern of the CAS NPs with a cubic structure synthesized by combining all precursors into one flask and heating to 300° C.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In one embodiment, the present disclosure provides a method for synthesizing copper (Cu), arsenic (As), and chalcogen containing nanoparticles. A group of precursors containing Cu and As is suspended in a solution providing precursor solvent A and a second group of precursors containing sulfur (S), selenium (Se), tellurium (Te), or combination thereof, is suspended in a solution providing solution B. Precursor solutions A and B are reacted together in one or more solvents under conditions sufficient for forming CAS NPs. The CAS NPs can also be formed by mixing Cu, As, and chalcogenide(s) in a single reaction mixture and providing conditions necessary for the reaction mixture to form nanoparticles.

Precursor solution A can include, but is not limited to (1) elemental Cu, As, or combination thereof; (2) an alloy of Cu, As, or combination thereof; (3) a salt of Cu, As, or combination thereof; (4) a complex of Cu, As, or combination thereof; (5) a chalcogenide of Cu, As, or combination thereof.

Precursor solution B can include, but is not limited to: (1) elemental chalcogens (e.g. S, Se, Te, etc.); (2) chalcogen containing compounds; (3) complexes of S, Se, Te, or combinations thereof.

Exemplary solvents include alkanes, alkenes, phosphines, alkane derivatives, alkene derivatives, and combinations thereof, including alkane and alkene derivatives having at least, but not limited to, one amine, amide, carboxylic acid, ether, phosphonic acid, thiol, or sulfoxide functional group.

To provide a clear understanding of the specifications and claims, the following definitions are provided.

As used herein, the term chalcogen refers to at any group 16 element in the periodic table (e.g. S, Se, Te, etc.) or combination thereof.

As used herein, the term nanoparticle means a single particle which can have a single dimension measuring at least, but not limited to about 1 to about 1000 nm and can be amorphous, crystalline, or polycrystalline.

As used herein, the term precursor can be used with reference to an organic or inorganic compound or reactant solution used in the nanoparticle synthesis process.

As used herein, the term complex can contain Cu, As, or a combination thereof which can be coordinated to one or more donor atoms. Examples can include, but are not limited to, copper acetylacetonate and triphenylarsine.

As used herein, the term chalcogenide refers to compounds containing copper, arsenic, or a combination thereof and oxygen, sulfur, selenium, tellurium, or combination thereof. Examples of chalcogenides are, but not limited to, CuO, CuS, CuSe, CuTe, Cu₂O, Cu₂S, Cu₂Se, Cu₂Te As₂O₃, As₂S₃, As₂Se₃, As₂Te₃, As₂O₅, As₂S₅, As₂Se₅, As₂Te₅ and combinations thereof.

As used herein, the term salt refers to acetates, halides (e.g. chlorides, bromides, iodides, etc.), nitrites, nitrates, sulfites, sulfates, hydroxides, or combinations thereof.

As used herein, the term elemental refers to a substance consisting of atoms with the same number of protons. Examples include, but are not limited to, Cu, As, S, Se, and Te.

As used herein, the term alloy can be a combination of elemental forms of Cu and As at various atomic ratios.

As used herein, the term silyl chalcogen can be a compound where a silicon can be bound to a chalcogen. An example includes, but is not limited to, bis(trimethylsilyl sulfide).

As used herein, the term “LUZ” refers to a NP having a composition of Cu₃As(Sₓ,Se_{y},Te_{z})₄, where x+y+z=1, 0≦x≦1, 0≦y≦1, and 0≦z≦1.

As used herein, the term “TEN” refers to a NP having a composition of Cu₁₂As₄(Sₓ,Se_{y},Te_{z})₁₃ or Cu₃As(Sₓ,Se_{y},Te_{z})₃ where x+y+z=1, 0≦x≦1, 0≦y≦1, and 0≦z≦1.

As used herein, the term “stoichiometric” can be applied to nanoparticle composition or precursors used for nanoparticle synthesis. Stoichiometric nanoparticle composition refers to a relative atomic ratio between the elements of the NP/s. When applied to precursors, it represents the molar ratios of the elements in the precursor. Due to the small size of nanoparticles, defects can influence overall stoichiometry resulting in a balanced or unbalanced stoichiometry. A balanced stoichiometric formula is one with enough of each element to complete the formed crystal structure having all sites occupied in the lattice. An unbalanced “stoichiometric” formula has a deficiency and/or excess of one or more elements with respect to the other elements. In practice, most nanoparticle systems exhibit an unbalanced stoichiometry and are also included in the present disclosure.

LUZ NPs and their Synthesis:

The present disclosure provides methods for synthesizing LUZ NPs comprising Cu, As, S, Se, and Te. More specifically, synthesis under these conditions can form individual LUZ NPs having an elemental composition of denoted by Cu₃As(Sₓ,Se_{y},Te_{z})₄, where x+y+z=1, 0≦x≦1, 0≦y≦1, and 0≦z≦1.

The LUZ NPs can be characterized by the following atomic ratios:

$$\frac{Cu}{As} = {X}_{1} ; and$$

$$\frac{( S + Se + Te )}{( Cu + As )} = {X}_{2} .$$

In one embodiment, the present disclosure provides stoichiometric LUZ NPs where X₁ is 3 and X₂ is 1.

The present disclosure provides non-stoichiometric LUZ NPs. Non-stoichiometric LUZ NPs can contain molar ratios of one or more elements deficient and/or in excess relative to stoichiometric LUZ NPs. Therefore, non-stoichiometric LUZ NPs can be Cu rich, Cu poor, As rich, As poor, chalcogen rich, or chalcogen poor. In a Cu rich LUZ, X₁>3; in a Cu poor LUZ, X₁<3; in chalcogen (S+Se+Te) rich LUZ, X₂>1; in chalcogen poor LUZ, X₂<1. It is also possible for the copper, arsenic and chalcogen containing nanoparticles to have an atomic composition denoted by Cu_{3+w}As(S₁₋ₓ,Se_{1-y},Te_{1-z})₄ where −0.75≦w≦0.5, x+y+z=1, 0≦x,y,z≦1.

In one embodiment, LUZ NPs are synthesized by reacting a first group of precursors (precursor solution A) with a second group of chalcogen containing precursor/s (precursor solution B) in one or more compatible solvents under conditions to favorably form LUZ NPs denoted by Cu₃As(Sₓ,Se_{y},Te_{z})₄, where x+y+z=1, 0≦x≦1, 0≦y≦1, and 0≦z≦1. It addition, both groups of precursors and/or precursor solutions can be combined into a reaction vessel which can contain one or more compatible solvents forming the reaction mixture. The reaction can be initiated about room temperature to about 250° C., preferably between 125° C. to 225° C.

Precursor solution A comprises Cu and As containing compounds. Examples of Cu and As containing compounds are, but not limited to (1) elemental forms of Cu and As; (2) alloys of Cu and As, such as, but not limited to, Cu₃As; (3) salts of Cu and As, including halides such as copper chloride, arsenic trichloride, arsenites, such as sodium arsenite, arsenates, such as potassium arsenate; (4) complexes of copper and/or arsenic, such as copper acetylacetonate, triphenylarsine; (5) chalcogenides of Cu and/or As, such as oxides, sulfides, selenides and tellurides, including but not limited to CuO, CuS, CuSe, CuTe, Cu₂O, Cu₂S, Cu₂Se, Cu₂Te, As₂O₃, As₂S₃, As₂Se₃, As₂Te₃, As₂O₅, As₂S₅, As₂Se₅, As₂Te₅, as well as ternary compounds and mixtures thereof; (6) and combinations thereof.

The second group of precursors can include (1) elemental chalcogen (e.g. S, Se, Te, etc.) in, but not limited to, powder, flake, pellet, bead, bulk, or vapor form; (2) chalcogen compounds, including but not limited to H₂S, H₂Se, Na₂S, Na₂Se, diethyl selenium, thiourea, selenourea, and gaseous derivatives thereof; (3) chalcogenides; (4) chalcogen complexes, including but not limited to oleylamine-sulfur complex, oleylamine-selenium complex, trioctylphosphine-sulfur complex, and trioctylphosphine-selenium complex; (5) amine and/or thiol complexes formulated by the methods of U.S. Provisional Patent Application No. 61/906,926, entirety of which is hereby incorporated by reference into the present disclosure; (6) silyl chalcogens, including but not limited to bis(trimethylsilyl sulfide); or a mixture thereof.

Precursor solutions A and B can be suspended in one or more compatible solvents to form respective precursor solutions. In addition, both groups of precursors can be suspended in a solvent or solvent mixture to form a single precursor solution. Exemplary solvents include alkanes, alkenes, alkane derivatives, alkene derivatives, and combinations thereof, including alkane and alkene derivatives having at least, but not limited to, one amine, amide, carbonate, carboxylic acid, ether, phosphine, phosphine oxide, phosphonic acid, thiol, or sulfoxide functional group. Furthermore, non-coordinating solvents (e.g. alkanes and alkenes) can be combined with coordinating ligands with one or more functional groups such as, but not limited to amines, amides, carbonates, carboxylic acids, ethers, phosphines, phosphine oxides, phosphonic acids, thiols and sulfoxides.

In one embodiment, the first group of precursors can be suspended in one or more solvent(s) providing precursor solution A and the second group of precursors can be suspended in one or more solvent(s) providing precursor solution B, whereby the precursor solutions A and B are combined to form a reaction mixture, which can be heated to a sufficient temperature (from about 50° C. to about 250° C.) under conditions suitable for forming LUZ NPs. NPs can be collected by centrifugation following the reaction of precursor solutions A and B.

The size, elemental composition, and stoichiometric properties of the LUZ NPs can be controlled by varying the Cu and As containing precursors, the chalcogen precursor, solvents, and synthesis conditions, as further described herein.

In an exemplary LUZ NP synthesis, precursors containing Cu and As are suspended in one or more compatible solvents (precursor solution A), which is heated to between about 50° C. and about 100° C. with stirring. A second group of chalcogen precursor containing S, Se, Te, or a combination thereof (precursor solution B), is heated to about 65° C. with stirring. A reaction vessel containing a compatible solvent or mixture of solvents, is heated under vacuum to about 130° C. for about 30 min. The reaction vessel is evacuated and refilled with argon several times at which point, the temperature is adjusted to between about 100° C. to about 300° C., whereupon the chalcogen precursor solution B is added to the reaction vessel. Within a short time (for example 20 seconds), precursor solution A is added to the reaction vessel forming the reaction mixture. The reaction mixture proceeds to completion then the reaction mixture is cooled to below 40° C. The NPs are collected by centrifugation with a suitable solvent/antisolvent or mixture thereof, such as 3:1 mixture of chloroform and ethanol.

A NP precipitate can be redispersed in a suitable solvent, such as chloroform, forming a stable NP ink solution.

TEN Nanoparticles and their Synthesis:

The present disclosure provides methods for synthesizing TEN nanoparticles comprising Cu, As, S, Se, and Te. More specifically, synthesis under these conditions can form individual TEN NPs having an elemental composition of denoted by Cu₁₂As₄(Sₓ,Se_{y},Te_{z})₁₃, where x+y+z=1, 0≦x≦1, 0≦y≦1, and 0≦z≦1.

The TEN nanoparticles can be characterized by the following atomic ratios:

$$\frac{Cu}{As} = {X}_{3} ; and$$

$$\frac{( S + Se + Te )}{( Cu + As )} = {X}_{4} .$$

In one embodiment, the present disclosure provides stoichiometric TEN nanoparticles where X₃ is 3 and X₄ is 0.81.

The present disclosure provides non-stoichiometric TEN nanoparticles. Non-stoichiometric TEN nanoparticles can contain molar ratios of one or more elements deficient and/or in excess relative to stoichiometric TEN nanoparticles. Therefore, a non-stoichiometric TEN nanoparticle can be copper (Cu) rich, Cu poor, arsenic (As) rich, As poor, chalcogen rich, or chalcogen poor. In a Cu rich TEN, X₃>3; in a Cu poor TEN, X₃<3; in chalcogen (S+Se+Te) rich TEN, X₄>0.81; in chalcogen poor TEN, X₂<0.81.

In one embodiment, TEN NPs are synthesized by reacting a first group of precursors (precursor solution A) with a second group of chalcogen containing precursor/s (precursor solution B) in one or more compatible solvents under conditions to favorably form TEN NPs denoted by Cu₁₂As₄(Sₓ,Se_{y},Te_{z})₁₃, where x+y+z=1, 0≦x≦1, 0≦y≦1, and 0≦z≦1. It addition, both groups of precursors and/or precursor solutions can be combined into a reaction vessel which can contain one or more compatible solvents forming the reaction mixture. The reaction can be initiated from about 225° C. to about 350° C., preferably between 250° C. to 300° C.

Precursor solution A comprises Cu and As containing compounds. Examples of Cu and As containing compounds are, but not limited to (1) elemental forms of Cu and As; (2) alloys of Cu and As, such as, but not limited to, Cu₃As; (3) salts of Cu and As, including halides such as copper chloride, arsenic trichloride, arsenites, such as sodium arsenite, arsenates, such as potassium arsenate; (4) complexes of copper and/or arsenic, such as copper acetylacetonate, triphenylarsine; (5) chalcogenides of Cu and/or As, such as oxides, sulfides, selenides and tellurides, including but not limited to CuO, CuS, CuSe, CuTe, Cu₂O, Cu₂S, Cu₂Se, Cu₂Te, As₂O₃, As₂S₃, As₂Se₃, As₂Te₃, As₂O₅, As₂S₅, As₂Se₅, As₂Te₅, as well as ternary compounds and mixtures thereof; (6) and combinations thereof.

The second group of precursors can include (1) elemental chalcogen (e.g. S, Se, Te, etc.) in, but not limited to, powder, flake, pellet, bead, bulk, or vapor form; (2) chalcogen compounds, including but not limited to H₂S, H₂Se, Na₂S, Na₂Se, diethyl selenium, thiourea, selenourea, and gaseous derivatives thereof; (3) chalcogenides; (4) chalcogen complexes, including but not limited to oleylamine-sulfur complex, oleylamine-selenium complex, trioctylphosphine-sulfur complex, and trioctylphosphine-selenium complex; (5) amine and/or thiol complexes formulated by the methods of U.S. provisional patent application No. 61/906,926, entirety of which is incorporated by reference in the present disclosure; (6) silyl chalcogens, including but not limited to bis(trimethylsilyl sulfide); or a mixture thereof.

Precursor solutions A and B can be suspended in one or more compatible solvents to form respective precursor solutions. In addition, both groups of precursors can be suspended in a solvent or solvent mixture to form a single precursor solution. Exemplary solvents include alkanes, alkenes, alkane derivatives, alkene derivatives, and combinations thereof, including alkane and alkene derivatives having at least, but not limited to, one amine, amide, carbonate, carboxylic acid, ether, phosphine, phosphine oxide, phosphonic acid, thiol, or sulfoxide functional group. Furthermore, non-coordinating solvents (e.g. alkanes and alkenes) can be combined with coordinating ligands with one or more functional groups such as, but not limited to amines, amides, carbonates, carboxylic acids, ethers, phosphines, phosphine oxides, phosphonic acids, thiols and sulfoxides.

In one embodiment, the first group of precursors can be suspended in one or more solvent(s) providing precursor solution A and the second group of precursors can be suspended in one or more solvent(s) providing precursor solution B, whereby the precursor solutions A and B are combined to form a reaction mixture, which can be heated to a sufficient temperature (from about 225° C. to about 300° C.) under conditions suitable for forming TEN NPs. NPs can be collected by centrifugation following the reaction of precursor solutions A and B.

The size, elemental composition, and stoichiometric properties of the TEN NPs can be controlled by varying the Cu and As containing precursors, the chalcogen precursor, solvents, and synthesis conditions, as further described herein.

In an exemplary TEN NP synthesis, precursors containing Cu and As are suspended in one or more compatible solvents (precursor solution A), which is heated to between about 50° C. and about 100° C. with stirring. A second group of chalcogen precursor containing S, Se, Te, or a combination thereof (precursor solution B), is heated to about 65° C. with stirring. A reaction vessel containing a compatible solvent or mixture of solvents, is heated under vacuum to about 130° C. for about 30 min. The reaction vessel is purged and refilled with argon several times at which point, the temperature is adjusted to between about 225° C. to about 350° C., whereupon the chalcogen precursor solution B is added to the reaction vessel. Within about 20 seconds, precursor solution A is added to the reaction vessel forming the reaction mixture. The reaction mixture proceeds to completion then the reaction mixture is cooled to below 40° C. The NPs are collected by centrifugation with a suitable solvent/antisolvent or mixture thereof, such as 3:1 mixture of chloroform and ethanol.

A NP precipitate can be redispersed in a suitable solvent, such as chloroform, forming a stable NP ink solution.

### EXAMPLES

### Example 1

### LUZ Nanoparticle (x=1, y=0 and z=0) Synthesis at Various Temperatures

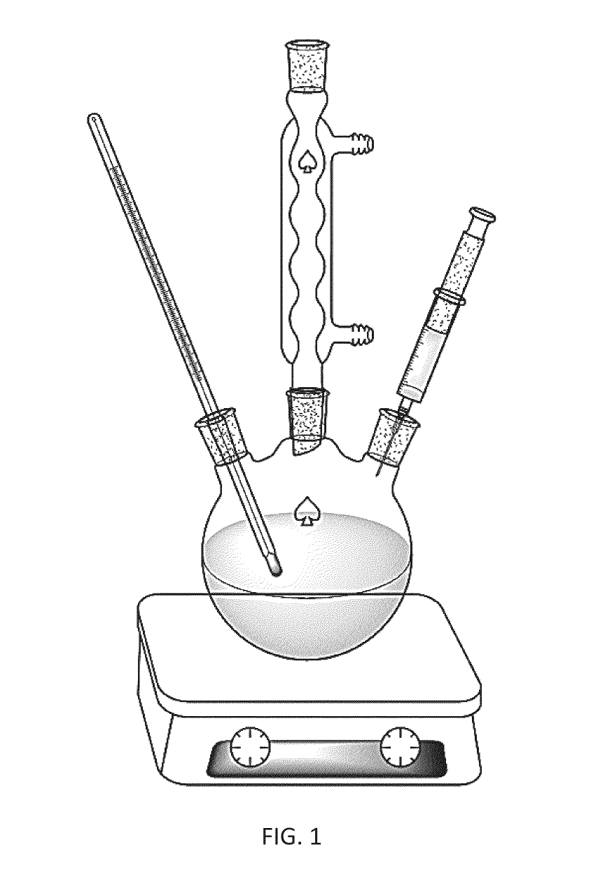

Standard air-free and Schlenk techniques are followed for the synthesis of the LUZ NPs. Oleylamine (80-90% Acros Organics, OLA) used for synthesis was degassed by freeze, pump, thaw and stored in an inert environment. In an exemplary LUZ NP synthesis, two precursor solutions are reacted in a third flask containing OLA to form the LUZ NPs. In a round bottom flask, a sulfur-OLA solution is formulated by adding 4 mmol of sulfur powder (99.98%, Sigma-Aldrich) to 5 mL of OLA and heated with stirring to 65° C. for about 30 min to give precursor solution A. In another round bottom flask, 5 mL of OLA, 0.750 mmol of copper(I) chloride (99.995%, Sigma-Aldrich), and 0.268 mmol of arsenic trichloride (99.99%, Sigma-Aldrich) is heated to 85° C. for about 30 min with stirring to give precursor solution B. In a 100 mL 3-neck flask equipped with a condenser and thermocouple adapter, 7 mL of OLA is added. The 100 mL 3-neck flask is attached to a Schlenk line and evacuated and refilled with argon three times (FIG. 1). The flask is left under vacuum and heated to reflux (−130° C.) for about 1 h. The 3-neck flask is returned to argon atmosphere and the temperature is increased to about 100-350° C. (preferably from about 150-225° C.), at which point, 0.8 mL of precursor solution A is injected via syringe. After 20 s, 2.0 mL of precursor solution B is also rapidly injected into the 3-neck flask. The reaction proceeds for about 10 minutes to completion. The heating mantle is removed and the 3-neck flask is cooled to below 40° C. before opening to air for collection by centrifugation in a 3:1 mixture of ethanol and chloroform.

FIG. 1 shows a typical glassware setup used for NP synthesis.

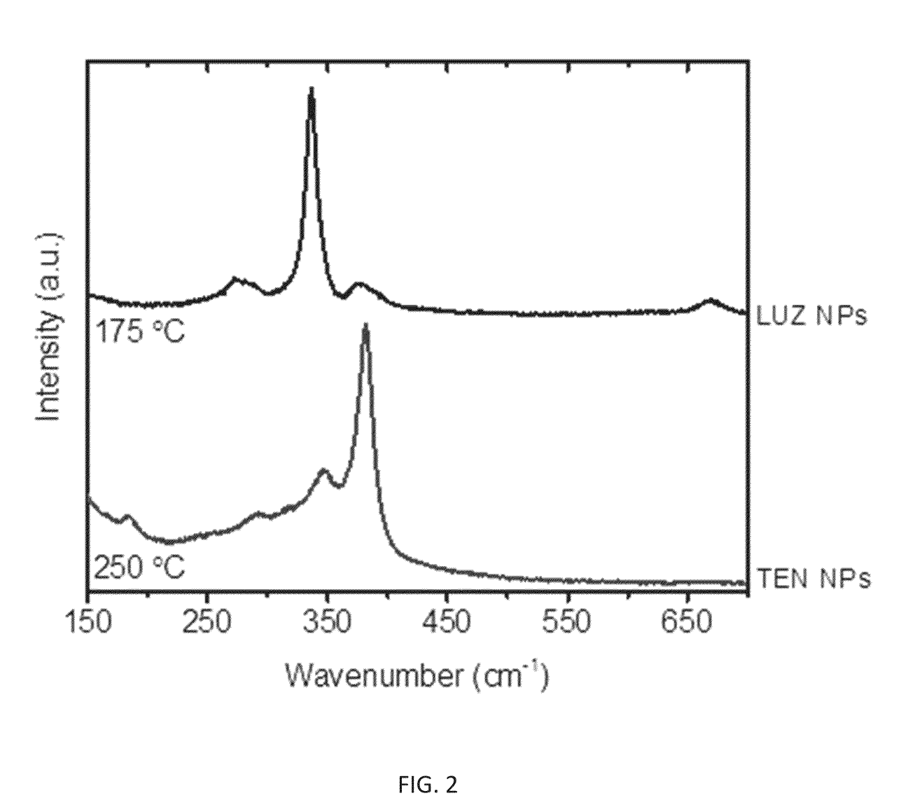

FIG. 2 shows the Raman spectrum obtained for the synthesized LUZ NPs at a temperature of 175° C. according to example 1. The obtained pattern closely matches the natural mineral form of LUZ RRUFF ID: R070247.

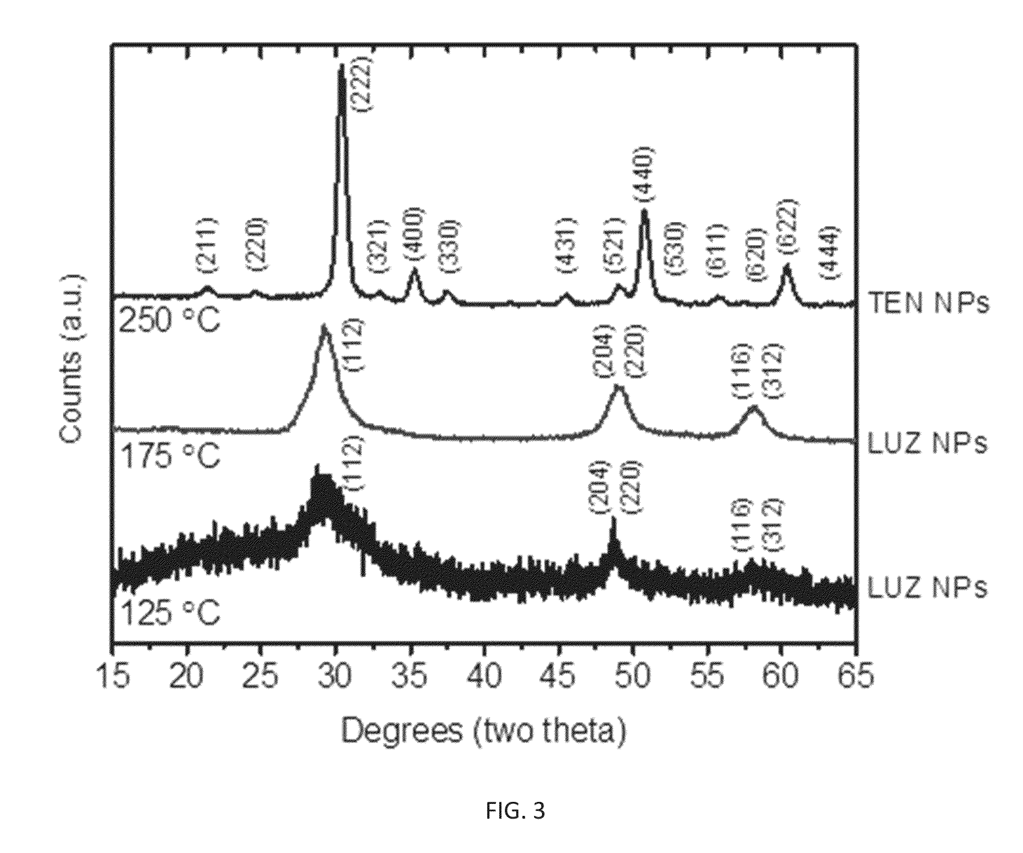

FIG. 3 shows the XRD patterns of the synthesized LUZ NPs at temperatures of 125° C. and 175° C. The differences in the full width half max for the 125° C. and 175° C. synthesis temperatures suggest different average size NPs suggesting the reaction temperature can be a way to control the NP size. The peak positions of the LUZ NPs also closely match the expected diffraction planes for the simulated crystal structure.

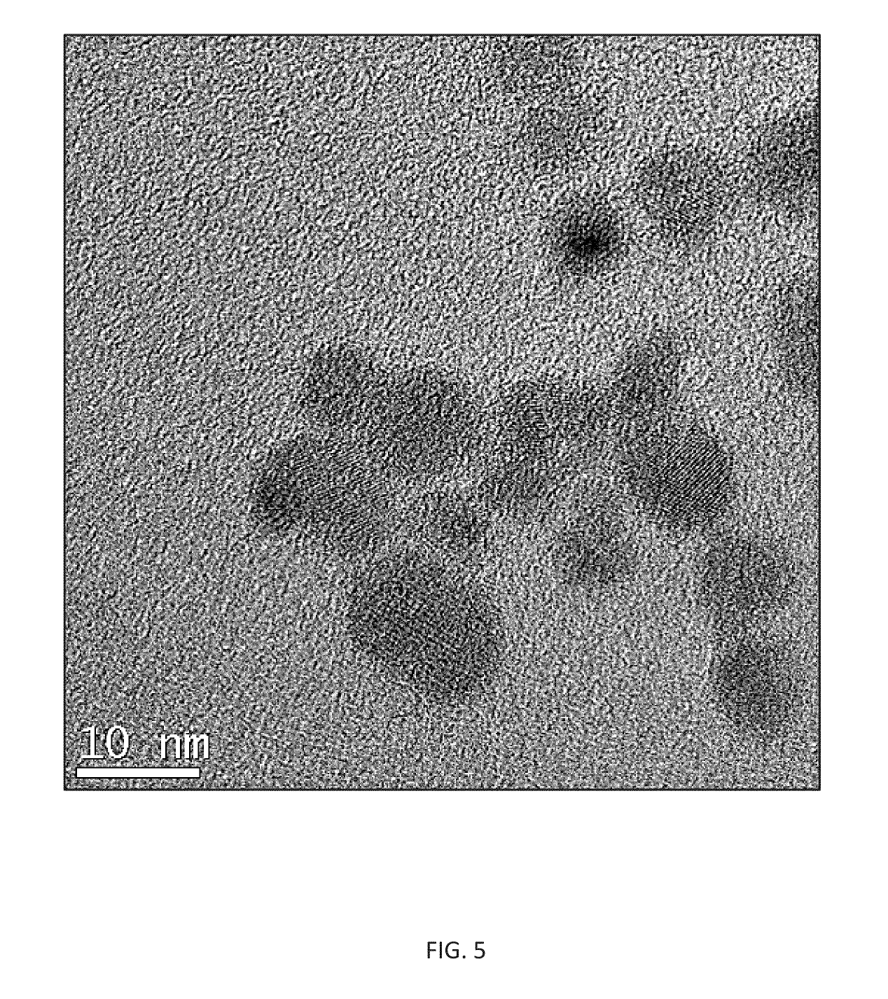

FIG. 5 shows a transmission electron microscopy (TEM) image of the synthesized LUZ NPs after collection and washing. The LUZ NPs have an average size distribution of 7.2±1.5 nm and an elemental composition of Cu_{2.8}AsS_{3.9} as determined by scanning electron microscopy energy dispersive X-ray spectroscopy (SEM-EDS).

### Example 2

### TEN Nanoparticle Synthesis (where x=1, y=0 and z=0)

TEN NPs are synthesized using the same procedure described in example 1, except with an injection temperature between about 225-350° C. (preferably about 250° C.) for precursor solutions A and B.

FIG. 2 shows the Raman spectrum obtained for the TEN NPs synthesized at 250° C. The Raman spectrum closely matches reported mineral form of TEN RRUFF ID: R050474.

FIG. 3 shows the XRD pattern of the as synthesized TEN NPs at 250° C., closely matching previous reports of TEN. The reflections have been assigned according to JCPDS #01-073-3934.

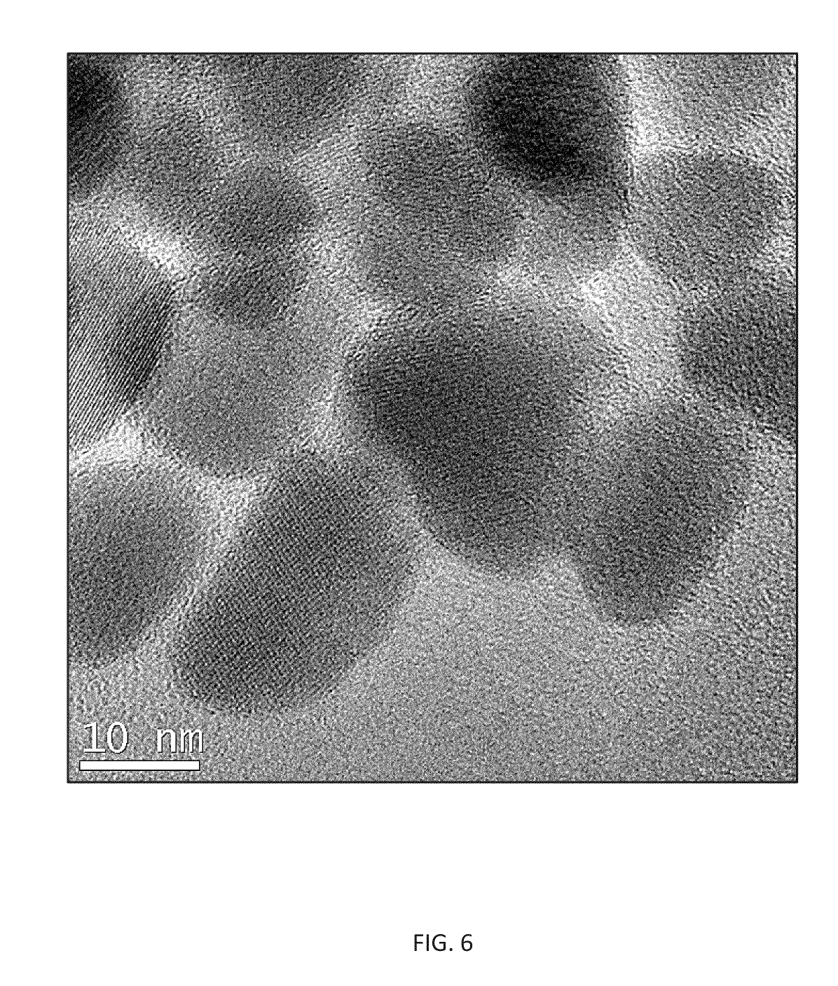

FIG. 6 shows a TEM image of the synthesized TEN NPs after collection and washing. The TEN NPs have an average size distribution of 22.6±4.7 nm and an elemental composition of Cu_{2.4}AsS_{4.5} as determined by SEM-EDS.

### Example 3

### LUZ Nanoparticle (where x=0, y=1 and z=0) Synthesis

Standard air-free and Schlenk techniques are followed for the synthesis of the Cu₃AsSe₄ (CASe) NPs. Oleylamine (80-90%, Acros Organics, OLA) used for synthesis was degassed by freeze, pump, thaw and stored in an inert environment. Ethanethiol (97%, Sigma-Aldrich, EtSH) was used as is. In an exemplary CASe NP synthesis, two precursor solutions are reacted in a third flask containing OLA to form the CASe NPs. In a round bottom flask, a selenium-OLA solution is formulated by adding 5 mmol of selenium powder (99.99%, Sigma-Aldrich) to 5 mL of OLA and 2.5 mL of EtSH and heated with stirring to 40° C. for about 30 min to dissolve the selenium under argon. The flask is gently evacuated to remove the EtSH for about 60 minutes providing precursor solution A. In another round bottom flask, 5 mL of OLA, 0.750 mmol of copper(I) chloride (99.995%, Sigma-Aldrich), and 0.268 mmol of arsenic trichloride (99.99%, Sigma-Aldrich) is heated to 85° C. for about 30 min with stirring to give precursor solution B. In a 100 mL 3-neck flask equipped with a condenser and thermocouple adapter, 7 mL of OLA is added. The 100 mL 3-neck flask is attached to a Schlenk line and evacuated and refilled with argon three times (FIG. 1). The flask is left under vacuum and heated to reflux (−130° C.) for about 1 h. The 3-neck flask is returned to argon atmosphere and the temperature is increased to about 100-350° C. (preferably from about 150-250° C.), at which point, 1.6 mL of precursor solution A is injected via syringe. After a short time (for example 20 s), 2.0 mL of precursor solution B is also rapidly injected into the 3-neck flask. The reaction proceeds for about 10 minutes to completion. The heating mantle is removed and the 3-neck flask is cooled to below 40° C. before opening to air for collection by centrifugation in a 3:1 mixture of ethanol (EtOH) and chloroform followed by two additional washes with 1:1:10 EtSH, OLA and EtOH.

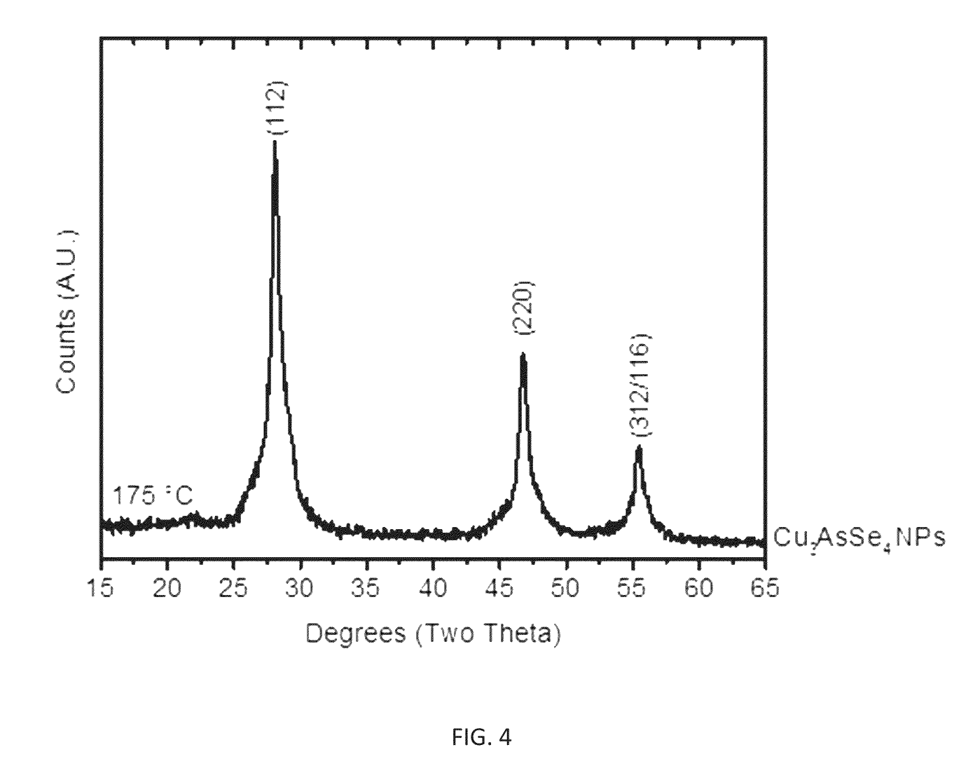

FIG. 4 shows the reflections from the obtained XRD pattern of the as synthesized CASe NPs at 175° C., closely matching previous literature reports.

### Example 4

### One Flask TEN Nanoparticle Synthesis

TEN NPs are synthesized using the same procedure described in example 1, except all precursors were combined into one flask with OLA. The temperature was then increased to between about 225-350° C. (preferably about 250° C.) then cooled to below about 40° C. before collecting by centrifugation.

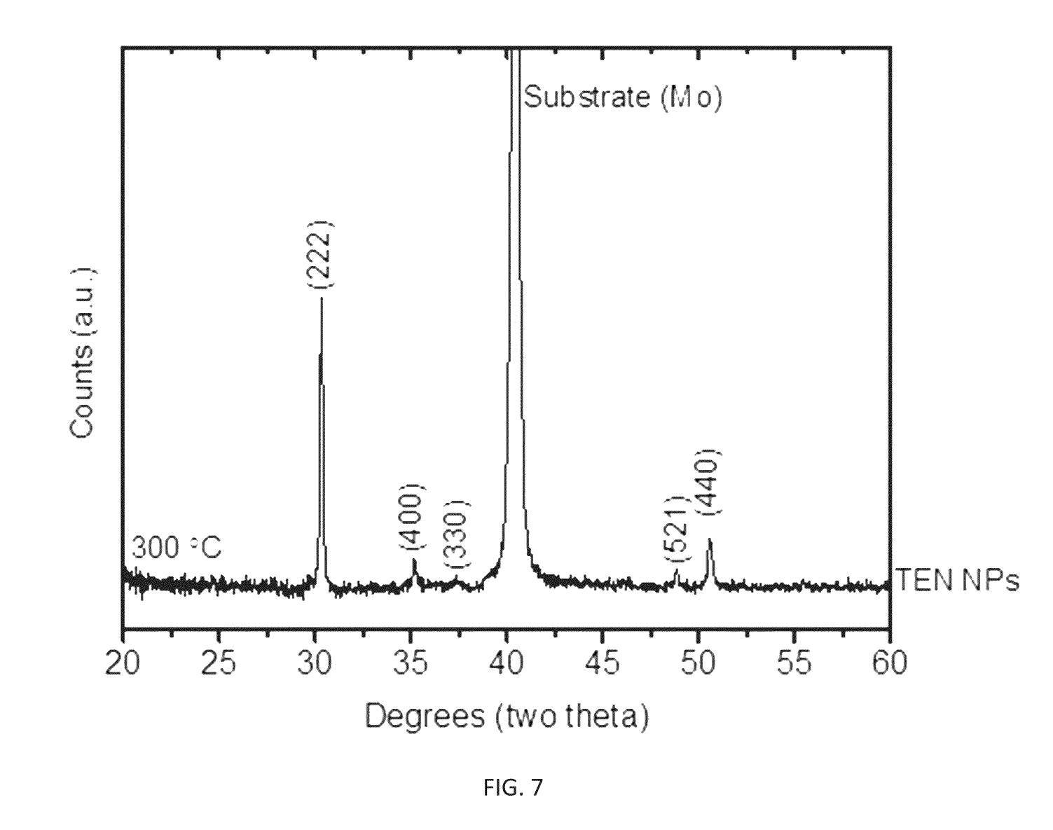

FIG. 7 shows the obtained XRD pattern of the as synthesized TEN NPs at 300° C., closely matching JCPDS #01-073-3934.

Those skilled in the art will recognize that numerous modifications can be made to the specific implementations described above. The implementations should not be limited to the particular limitations described. Other implementations may be possible.

### REFERENCES

(1) Guo, Q.; Ford, G. M.; Yang, W.-C.; Walker, B. C.; Stach, E. A.; Hillhouse, H. W.; Agrawal, R. J. Am. Chem. Soc. 2010, 132, 17384-17386.
(2) Hages, C. J.; Levcenco, S.; Miskin, C. K.; Alsmeier, J. H.; Abou-Ras, D.; Wilks, R. G.; Bar, M.; Unold, T.; Agrawal, R. Prog. Photovoltaics Res. Appl. 2013, n/a-n/a.
(3) Larramona, G.; Bourdais, S.; Jacob, A.; Choné, C.; Muto, T.; Cuccaro, Y.; Delatouche, B.; Moisan, C.; Péré, D.; Dennler, G. RSC Adv. 2014, 4, 14655.
(4) Miskin, C. K.; Yang, W.-C.; Hages, C. J.; Carter, N. J.; Joglekar, C. S.; Stach, E. A.; Agrawal, R. Prog. Photovoltaics Res. Appl. 2014, 57, n/a-n/a.
(5) Yu, L.; Kokenyesi, R. S.; Keszler, D. a.; Zunger, A. Adv. Energy Mater. 2013, 3, 43-48.
(6) Pauporté, T.; Lincot, D. Adv. Mater. Opt. Electron. 1995, 5, 289-298.
(7) Shi, T.; Yin, W.-J.; Al-Jassim, M.; Yan, Y. Appl. Phys. Lett. 2013, 103, 152105.
(8) Wernick, J. H. Semiconducting Materials and Devices Made Therefrom. U.S. Pat. No. 2,882,193, 1959.
(9) Golovej, J. V. Voroshilov, and M. V. Potorij, Izv. Vyss. Uch. Zaved., The ternary systems Cu(Ag,Tl)—B(5)-Se. Khym I Khym. Tekh. 28, 7 (1985).

1. A method for obtaining copper, arsenic, and chalcogen containing nanoparticles, comprising:
providing a first group of precursors, the first group of precursors comprising copper and arsenic;
providing a second group of precursors, the second group of precursors comprising sulfur, selenium, tellurium, or a mixture thereof; and
reacting both the first group of precursors and the second group of precursors in at least one solvent at conditions forming copper arsenic chalcogen nanoparticles.

2. The method of claim 1, wherein the copper arsenic and chalcogen containing nanoparticles can have an atomic composition denoted by Cu_{3-w}As(S₁₋ₓSe_{1-y},Te_{1-z})₄ where −0.75≦w≦0.5, x+y+z=1, 0≦x,y,z≦1.

3. The method of claim 1, wherein the first group of precursors comprises at least one copper and arsenic component from at least one of elemental copper, arsenic, or combination thereof, alloy of copper, arsenic, or a combination thereof, salt of copper, arsenic, or combination thereof, organic complex of copper, arsenic, or combination thereof, and chalcogenide of copper, arsenic, or combination thereof.

4. The method of claim 3, wherein the second group of precursors comprises sulfur, selenium, tellurium, or combination with at least one of elemental sulfur, selenium, tellurium, or combination thereof, compound of sulfur, selenium, tellurium, or combination thereof, and a complex of sulfur, selenium, tellurium, or combination thereof.

5. The method of claim 4, wherein the solvent comprises at least one alkane, alkene, alkane derivatives, alkene derivatives, or a mixture thereof.

6. The method of claim 5, wherein the alkane or alkene derivative comprises at least one functional group comprising an amine, an amide, a carbonate, a carboxylic acid, an ether, a phosphine, a phosphonic acid, a thiol, or a combination thereof.

7. The method of claim 6, wherein the first and second group of precursors are suspended in one or more solvents forming a reaction mixture.

8. The method of claim 6, further comprising:
suspending the first group of precursors in one or more solvents forming precursor solution A;
suspending the second group of precursors in one or more solvents forming precursor solution B; and
combining precursor solutions A and B in a reaction flask containing one or more solvents forming a reaction mixture.

9. The method of claim 8, further comprising conducting the reaction at a temperature between about 50° C. and about 350° C.

10. The method of claim 9, further comprising:
heating one or more reaction solvents to between about 50° C. and 350° C.;
adding a precursor solutions A;
adding a precursor solution B;
heating one or more reaction solvents to between about 50° C. and 350° C.;
adding precursor solutions A and B simultaneously;
heating one or more reaction solvents to between about 50° C. and about 350° C.;
adding a solution containing one or more solvents and all precursors; and
heating all precursors in one or more solvents to between about 50° C. and 350° C.

11. The method of claim 10, comprising:
increasing reaction temperature after the addition of one or more precursors;
decreasing reaction temperature after the addition of one or more precursors; and
maintaining of reaction temperature after the addition of one or more precursors.

12. The method of claim 10, wherein heating the reaction mixture between about 50° C. to about 250° C. can give copper arsenic sulfide nanoparticles with a tetragonal crystal structure, hexagonal crystal structure, or combination thereof.

13. The method of claim 10, wherein heating the reaction mixture between about 250° C. and 350° C. can give copper arsenic sulfide nanoparticles with a cubic crystal structure.

14. The method of claim 12, wherein the nanoparticles are collected by centrifugation after the reaction of precursors in the reaction mixture.
